(19) United States
(12) Patent Application Publication
(10) Pub. No.: US 2006/0069789 A1
(43) Pub. Date: Mar. 30, 2006

(54) Apparatus and method for improved transfer of files using an internet protocol

(76) Inventor: Jason D. Kridner, Houston, TX (US)

Correspondence Address: TEXAS INSTRUMENTS INCORPORATED, P O BOX 655474, M/S 3999, DALLAS, TX, 75265, US

(21) Appl. No.: 10/950,823

(22) Filed: Sep. 27, 2004

(51) Int. Cl. G06F 15/16

(52) U.S. Cl. 709/230

(57) ABSTRACT

A file is to be transferred over the internet employs TCP/IP procedures to insure accurate transmission of the file. When, in a processing system, a URL request for a file is generated, a determination is made whether the requested file is stored in a device associated with processing system issuing the URL request. When the requested file is stored in a storage unit connected to the data processing system requesting the file, then the TCP/IP procedures are not used. When the file must be transferred over the internet, i.e., the device storing the requested file is not associated with the processing system requesting the file, then the TCP/IP procedures are employed. In this manner, the TCP/IP procedures have a reduced impact on the availability of the central processing unit.

### FIELD OF THE INVENTION

This invention relates to the transfer of files in data processing systems coupled to the internet and, more particularly, to the transfer of files using an internet protocol.

### BACKGROUND OF THE INVENTION

As the internet has become the medium for the communication between data processing systems, the transfer of files, such as music files, has created potential problems. Because of the traffic on the internet, the transmission of a file as a unit is impractical. Therefore, internet protocols were developed by which dissimilar data processing unit configurations could exchange files pointed to by a universal resource locator (URL). In the transmission control protocol/internet protocol (TCP/IP), the file was divided into packets, each packet having a destination address. Each packet also was provided with the information that indicated the order in which the packets were to be reassembled and the ability to recognize and identify when a packet was lost in a file exchange.

Referring to FIG. 1, a data processing system 10, coupled to the internet 17, includes a processing unit 11 coupled to a storage unit 12 and to at least one storage device 15. The processing unit 11 includes a central processing unit 111 and a local memory unit 112. The central processing unit 111 receives a URL request for the file or generates a URL request for the file. The local memory unit 112 of the central processing unit 111 associated with the device in which the file is stored retrieves the file. The central processing unit retrieves the TCP/IP file from locations 112A. The TCP/IP file supplies the procedures for the conversion of the requested file into packets and the file requested is transferred to the destination address. In the central processing unit associated with the storage unit to which the URL is directed, the TCP/IP file 102A provides the procedures for processing the requested file packet, e.g., adding the error correcting portion. The file is then stored in the target storage unit.

Referring to FIG. 2, the procedure for transferring files in response to a URL request, according to the prior art, is illustrated. A URL request for a transfer of a requested file to a specified storage unit is received by the central processing unit in step 201. In step 202, the requested file is retrieved from the storage location and processed with the TCP/IP protocol. The requested file is transmitted as packets to the target destination in step 203. In step 204, a determination is made whether the last packet has been received. When the last packet has not been received, the process returns to step 203 for the continuing transmission of packets. When, in step 204, the last packet has been received, then in step 205, a determination is made whether the transfer of the requested file is complete. When the file transfer is not complete, then the missing requested file packets are retransmitted in step 206. Upon receipt of the retransmitted file packets the determination in step 205 is performed once again. When the determination in step 205 is positive, then the process is at an end.

The discussion of FIG. 2 has presented a summary of the activity in responding to URL request, a more comprehensive explanation is herewith provided. Two major models for file transfer using TCP/IP file transfer are used, the “push” model and the “pull” model. The pull model is used in most transfers and this model is the basis of the following description. An application program on the originating processor requests a file transfer using the URL (universal resource locator). A function within that program creates an HTTP request packet from the URL and calls a socket function to send that packet using TCP. The socket function, typically a Berkeley socket or a WinSock socket:

a.) places a TCP header at the beginning of the request packet, breaking it up if necessary;

b.) stores the request packet data such that the request can be resent;

c.) places and IP header at the beginning of the request packet(s) to route the packets to route the packets; and

d.) provides the request packet(s) to the socket driver that will perform the physical transfer.

The socket driver then sends the request packet(s) to the target device. The target processor device receives the request packet(s). The target processor sends the data packet(s) to the originating device. The socket driver receives the file data packets from the target device and forwards them to the socket library. The socket library:

a.) removes the IP header to determine that the file packets are destined for the originating processor, b.) processes the TCP header to determine that the file packet(s) are valid and sends the status packets to the socket driver as necessary, and c.) provides the file data packets to the application program.

The TCP/IP procedures are computationally intensive. The information transmitted with the packet(s) must include the destination address and permit the transfer of the file to recover from missing packets and, because the packets can travel through a variety of paths on the internet, the packets must include information that can permit the file to be reassembled in order and errors to be detected.

A need has therefore been felt for apparatus and an associated method having the feature that the computational requirements on the central processing system are reduced. It would be another feature of the apparatus and associated method to provide, when a file is requested for storage in a different storage unit over the internet, that the processing include the TCP/IP procedures. It would be yet another feature of the apparatus and associated method to transfer files between different storage units of the same data processing system without implementation of the TCP/IP procedures.

### SUMMARY OF THE INVENTION

The aforementioned and other features are accomplished, according to the present invention, by determining, when an application program in a processing system coupled to the internet requests a file transfer, whether the file is stored in a device associated with the data processing system or not. When the file is stored in a device not associated with the data processing system, then the TCP/IP procedures are employed to permit accurate transfer of files over the internet. When the file is to be transferred between storage units coupled to the data processing system, then the file is transferred without the TCP/IP procedures.

Other features and advantages of the present invention will be more clearly understood upon reading of the following description and the accompanying drawings and claims.

### BRIEF DESCRIPTION OF THE DRAWINGS

FIG. 1 is a block diagram data processing system coupled to the internet according to the prior art.

FIG. 2 illustrates the process for the transfer of a requested URL file according to the prior art.

FIG. 3 illustrates the process for transfer of requested URL file according to the present invention.

### DESCRIPTION OF THE PREFERRED EMBODIMENT

1. Detailed Description of the Drawings

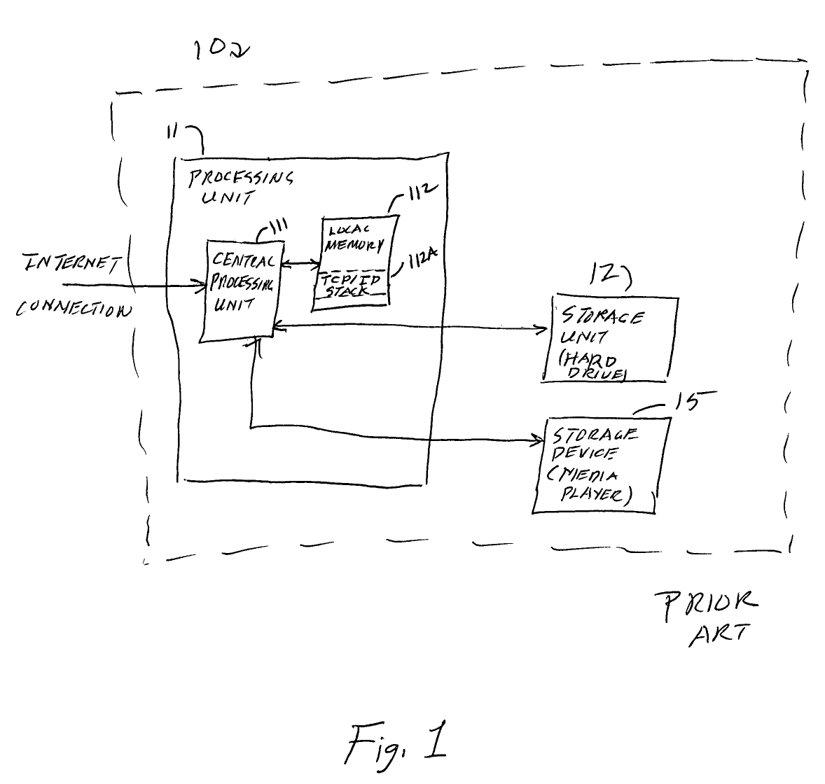

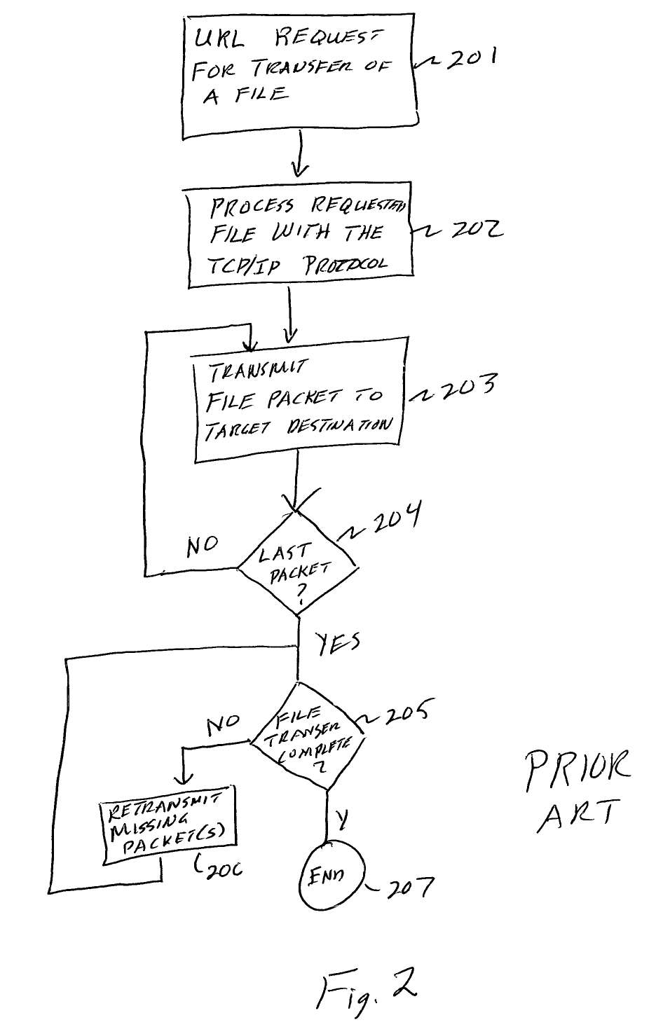

FIG. 1 and FIG. 2 have been described with respect to the related art.

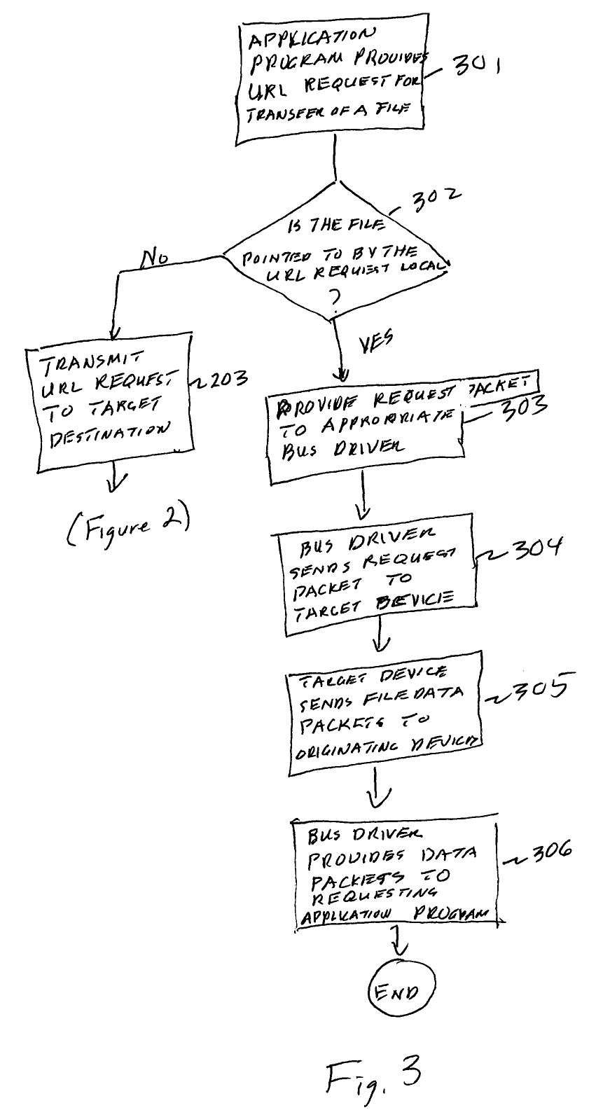

Referring to FIG. 3, the process for obtaining a file for a program, according to the present invention is shown. In step 301, an application program provides a URL request for the transfer of a file. In step 302, the determination is made whether the file pointed to by the URL request is a local file, i.e., a file associated with the requesting processing unit. When the requested file is not a.local file, then the process proceeds to step 203 in FIG. 2 and subsequently follows the procedure shown in FIG. 2. When the result of the determination in step 302 is positive, then the request packet is transferred to the appropriate bus driver in step 303. In step 304, the bus driver delivers the request packet to the target device. In response to the request packet, the target device sends the requested file packet to the bus driver of the originating device in step 305. In step 306, the bus driver transfers the data file packet to the application program.

2. Operation of the Preferred Embodiment

The process illustrated by FIG. 3 can be describes as follows. The technique used is to intercept the socket library call and not to use the TCP/IP protocol when reliable transfer of files is available. In a typical file transfer, according to the present invention, an application program on the originating device requests a file using the URL (universal resource locator) techniques. A function within that program creates an HTTP request packet from the URL and calls a socket function to send that function using TCP procedures. In the implementation of the socket library according to the present invention:

a.) an examination of the request packet is made and the identification is made of the requested file as being connected over a bus with hardware support, such as USB; and

b.) the request packet is provided to the bus driver. The bus driver sends the request packet(s) to the target device. The target device receives the request packet(s). The target device sends the request packets to the originating device. The bus driver receives the file data packets from the target device and provides them to the new implementation of the socket library. The new implementation of the socket library provides the data packets directly to the application program without further processing.

The benefit of applying the present invention is to maintain compatibility through the use of standard socket library calls while providing significant performance gains. The target device retains the functionality of being able to allow any other device on the internet to pull its file (when the appropriate permission(s) are granted) and for the target processor to perform pulls from any device on the internet (when the appropriate permission(s) are granted). Furthermore, in the case that the new implementation of the socket library is not installed on the originating device, the original file transfer procedures are still in place, though these procedures may not be optimized.

Push-mode transfers work in a similar manner with the exception that both the request and the file packets are from the same originating device.

An example of the operation of the present invention is as follows. The socket driver is connected to a portable MP3 player using RNDIS over USB. RNDIS is the Microsoft Corporation approach to providing a common interface to networking peripherals. In addition to the RNDIS protocol, the portable MP3 player includes a separate set of data endpoints that receive and transmit data is a raw fashion without all of the TCP/IP requirements for potentially lossy networks. This separate set of endpoints is supported by a bus driver. To avoid the complication of modifying the WinSock library provided by Windows, the application is linked against a new implementation of the socket library that calls the WinSock version if it is not detected that the transmission is over a reliable bus.

While the invention has been described with respect to the embodiments set forth above, the invention is not necessarily limited to these embodiments. Accordingly, other embodiment variations, and improvements not described herein, are not necessarily excluded from the scope of the invention, the scope of the invention being defined by the following claims.

What is claimed is:

1. A data processing system coupled to the internet, the system comprising:
a central processing system;
a local memory unit coupled to the central processing unit, the local memory unit including a portion storing an internet procedure stack;
a storage unit storing files; and
a storage device storing files, wherein a transfer of files between the storage unit and the storage device does not invoke the internet procedure stack.

2. The system as recited in claim 1 wherein a file requested by the data processing unit to be transferred over the internet invokes the internet procedure stack.

3. The system as recited in claim 1 wherein the internet procedure stack is a TCP/IP protocol stack.

4. The system as recited in claim 1 wherein the storage unit is a hard disk drive.

5. The system as recited in claim 1 wherein the storage unit is a media player.

6. The system as recited in claim 1 wherein a URL is generated when a file is requested.

7. The system as recited in claim 6 wherein the response to the URL is invoke an internet driver when the file is to be transferred over the internet, and wherein the response to the URL is to invoke a bus driver when the requested file is not to be transferred over the internet.

8. The method of transferring a requested file by a data processing system, the method comprising;
processing the file with internet procedures when the URL file is transferred to the data processing system over the internet; and
transferring the file without internet procedures when the file is transferred between storage components coupled to the data processing system.

9. The method as recited in claim 8 further comprising implementing the internet procedures with TCP/IP procedures.

10. The method as recited in claim 8 further comprising using a URL to request the requested file.

11. The method as recited in claim 10 further comprising:
when the requested file is to be transferred over the internet, invoking an internet driver in response to the URL, and
when the requested file is not to be transferred over the internet, invoking a bus driver in response to the URL.

12. The method as recited in claim 8 wherein, in the transferring procedure, the requested file is transferred between a hard disk drive and a media player.

13. The system comprising:
an internet network;
a plurality of data processing systems coupled to the internet, each of the data processing systems includes transfer apparatus, the transfer apparatus transferring files, wherein at least one of the data processing systems has a plurality file storage units, the data processing systems providing a file requested over the internet to the internet after internet procedures have been applied thereto, the transfer of files between storage units associated with one of the data processing systems not requiring the internet procedure applied to the files.

14. The system as recited in claim 13 wherein the internet procedures are TCP/IP procedures.

15. The system as recited in claim 13 wherein a URL is generated when a file is need by an application program.

16. The system as recited in claim 15 wherein the response to the URL is invoke an internet driver when the file is to be transferred over the internet, and wherein the response to the URL is to invoke a bus driver when the requested file is not to be transferred over the internet.
